(19) United States
(12) Patent Application Publication
(10) Pub. No.: US 2005/0175960 A1
(43) Pub. Date: Aug. 11, 2005

(54) Medical, handpiece in particular for dentistry, with an outlet for an abrasive flowing medium and splashguard for the outlet

(76) Inventors: Hans-Dieter Wiek, Hochdorf (DE); Bernd Gugel, Ulm-Einsingen (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/510,085

(22) PCT Filed: Feb. 18, 2003
(86) PCT No.: PCT/EP03/01634

(30) Foreign Application Priority Data
Apr. 5, 2002 (DE) 20205274.5

(51) Int. Cl. A61C 3/02

(52) U.S. Cl. 433/88; 433/116

(57) ABSTRACT

The disclosure relates to a medical, in particular dental-medical handpiece, which has in its rearward end region a coupling connection for coupling on to a flexible supply hose, wherein at least one delivery line for an abrasive flow medium extends from the coupling connection to an outlet which is arranged in the forward end region of the handpiece and opens into a hood-form free space of a splash guard. To improve the releasable connection between the splash guard and the handpiece, the splash guard is releasably connected with the handpiece by means of a plug-in fitting having two plug-in fitting parts in the form of a plug-in recess and a plug-in pin that can be inserted therein, and a latching device integrated in the plug-in fitting, wherein the plug-in fitting has a spring tongue, elastically outwardly bendable transversely to the plug-in axis, with a latching nose arranged thereon on the one plug-in fitting part and an undercut on the other plug-in fitting part.

The invention relates to a medical, in particular dental-medical, handpiece and to a splash guard for the outlet of such a handpiece.

A handpiece and a splash guard of the kind concerned are described e.g. in EP 0 858 783 or in U.S. Pat. No. 6,325,624 D1 or in WO 96/12 447. Significant features of such a known handpiece are the rod form with a rearward coupling element for the releasable coupling on of the handpiece to a flexible supply hose for water and/or air and an outlet for an abrasive medium at the forward end of the handpiece, whereby in the case of a dental-medical handpiece the outlet is arranged to the side in order to ensure a flow of the abrasive medium transversely to the longitudinal middle axis of the handpiece. Such a side outlet is advantageous in order to have in the restricted mouth space of the patient sufficient possibilities for the treatment of desired tooth surfaces. In order to improve the action on the surface being operated upon with the out-flowing abrasive medium, in the case of the known handpieces there is releasably attached a splash guard having an open free space at its free end, whereby a delivery line for the abrasive medium opens in the free space. The opening of the free space is approximately adapted to the size of the surface to be treated. Due to the presence of the splash guard in the form of a concentrating hood the out-flowing abrasive medium is largely prevented from spreading out before or after impacting on the surface to be treated. Through this, the effectiveness of the abrasive medium on the surface to be treated is improved. In order to ensure, in functional operation, a continuous flow of the abrasive medium there are present in the circumferential wall surrounding the free space side exit openings which ensure a side exit of the medium for the purpose of maintaining the flow.

With the known configuration, the splash guard is a releasable and thus selectively removable component in the form of a pipe piece which can be mounted on directly or indirectly on a so-called cannula, which can be releasably connected with the grip part of the handpiece. With the configuration according to EP 0 858 783 A the splash guard can be mounted on to a head-like plate of the cannula. With the configuration in accordance with U.S. Pat. No. 6,325,624 B1 there is provided a bushing connection with an elastic clamping function of the bushing, whereby the pipe-like splash guard can be clampingly placed on a pipe-like outlet piece due to elastic expansion. Such a clamping connection is only effective in a force-locking manner and thus sensitive. There is the danger that the splash guard, in functional operation, releases itself from the handpiece and must be sought at the treatment site, which is time consuming, disrupting and unpleasant for the patient. In the case of the handpiece which can be understood from WO 96/12 447 a splash guard is connected by means of a latching device with a mounting part which is arranged on the cannula.

The object of the invention is, with a handpiece or a splash guard of the kinds concerned, to improve the releasable connection between the splash guard and the handpiece. In particular there is to be attained greater stability of the connection and security of the connection with regard to an unintended release of the connection. Thereby, the releasability should be fundamentally unaffected and if possible likewise improved, in order to ensure a handling-friendly mounting or release of the splash guard.

This object is achieved by means of the features of claim 1 or 7 or 15. Advantageous further developments of the invention are indicated in the associated subclaims.

In the case of the configuration in accordance with the invention according to claim 1 there is provided a latching device for connecting the splash guard with the handpiece, which is effective due to the elastic yieldability of a spring tongue. Due to the elastic yieldability, the splash guard can be pushed over the thickening of the latching body with a pushing force which can easily be applied manually, whereby the spring tongue bends outwards and in the latching disposition the at least one latching nose engages behind the undercut of the latching body. Through this, the security of the connection is improved in comparison with the known configurations. For releasing the splash guard there is required a certain easily applied pulling force, which overcomes the latching, whereby the latching nose is self-actingly moved or expanded into its open disposition.

In the latching disposition the latching nose, or also the feather tongue, bears on the latching body preferably with an elastic clamping tension, through which the connection or the seating is further stabilized, without making release more difficult.

Within the scope of the invention, the spring tongue and/or the latching nose may be configured in the form of a slotted ring or it may be formed as a segment, whereby also a plurality of spring tongues with latching noses; e.g. two or three, may be arranged opposite to one another in a segment form. Both for a ring-shaped latching nose and also for at least one segment-form latching nose it is advantageous to produce the pipe-form body of the splash guard or the latter in its entirety of a material of slight elastic expansion, but having an elastic flexibility, e.g. of plastics material, which makes possible a simple, rapid and economical production, in particular then when the splash guard is an injected molded part.

The above described advantages apply also for a splash guard in accordance with the invention according to independent claim 7.

A particularly advantageous configuration is then provided when the latching body has a ball-form or ball-section-form thickening, which the splash guard engages over and behind elastically. Such a rounded thickening provides an the same time a ramp-like introduction surface between the at least one latching nose and the latching body, which brings about a self-actuated movement of the latching nose upon the plugging together and thereby moves the latter into the release position. When, thereby, the surface of the one or the plurality of latching noses is adapted to the convex form of the spring tongues, there is provided beyond this a stable connection with a firm seating.

Depending on the configuration of the handpiece it is possible within the scope of the invention to provide the latching device between the pipe-form splash guard body itself and a latching body surrounding the outlet, or to arrange the latching body next to the outlet so that the splash guard also has the latching elements, which are latchable with a latching body on the handpiece, next to the actual splash guard body. Thereby it is further possible to arrange the latching body on the handpiece configured as a grip part or on a cannula which is preferably releasably connected with the grip part.

A site of operation or site of treatment is in many situations restrictedly accessible with the handpiece. This applies in particular for the mouth space of the patient and for a dental-medical handpiece. Thereby it is to be taken into account that the splash guard should be adapted with the edge of its splash guard body to the area of the treatment site in order to ensure a good functioning of the splash guard.

The invention thus further has the object of improving a splash guard in accordance with the preamble of claim 11 or claim 13 with regard to its adaptability to the treatment site and/or to differing treatments.

This object is achieved by means of the features in claim 11. Advantageous further developments of the invention are indicated in the associated subclaims.

In the case of the splash guard in accordance with the invention according to claim 11, the guard body is rotatably mounted around its longitudinal axis, and thus the guard body can be rotated into particular dispositions and thus adapted to the treatment site. This configuration is in particular then advantageous if the edge of the hood-form guard body is non-symmetrical with regard to the axis of rotation, e.g. has different edge heights. However, also if edge sections and edge recesses are arranged on the edge of the hood-form guard body, these can be displaced into desired positions by means of a rotary displacement. An advantageous further development consists e.g. in providing a segment-form edge section on one side, which for a treatment is moved into a certain circumferential position in which it protects the region lying therebehind from being acted upon with the abrasive flow medium. In the case of the treatment of a tooth it is e.g. advantageous to move the segment-like edge section into such a circumferential position in which it is located in front of a region to be protected, e.g. in front of the tooth pocket edge and in this position can protect the tooth pocket from being acted upon with the treatment medium.

With the configuration according to claim 13 there are provided a plurality of different guard bodies, which are selectively connectable indirectly or directly with the handpiece. Through this, in each case one of a plurality of guard bodies can be connected and used with the handpiece which is particularly suitable for the treatment concerned, e.g. having a particular form or size. It is e.g. advantageous to provide a plurality of splash guard parts the free height of which is different and which can be put to use depending upon the medical requirements.

With the configuration according to claim 15 the splash guard is connected with a cannula, preferably releasably connected with the handpiece or with a grip part of the handpiece, by means of a screw connection. A screw connection distinguishes itself through a great stability which also ensures a reliable connection in that the screw connection is tightened with a rotary tension and is thereby positioned in its respective screw end disposition in a self-locking manner.

In further subclaims there are features which relate to flow openings of the splash guard or to splash guard pins or segments present between the flow openings. A yieldable arrangement of the pins or segments is particularly advantageous in order to prevent a blocking of the free space and to make possible the yielding of at least one of the splash guard parts present. This can be achieved in that the splash guard parts are formed by means of elongate bodies, which e.g. are arranged in the manner of pins or in a brush-like manner directly neighboring one another or may have a spacing from one another and are overall elastically flexible or are elastically flexible at a joint, which is e.g. constituted in the form of a film hinge.

Below, advantageous configurations of the invention will be described in more detail with reference to preferred exemplary embodiments. There is shown

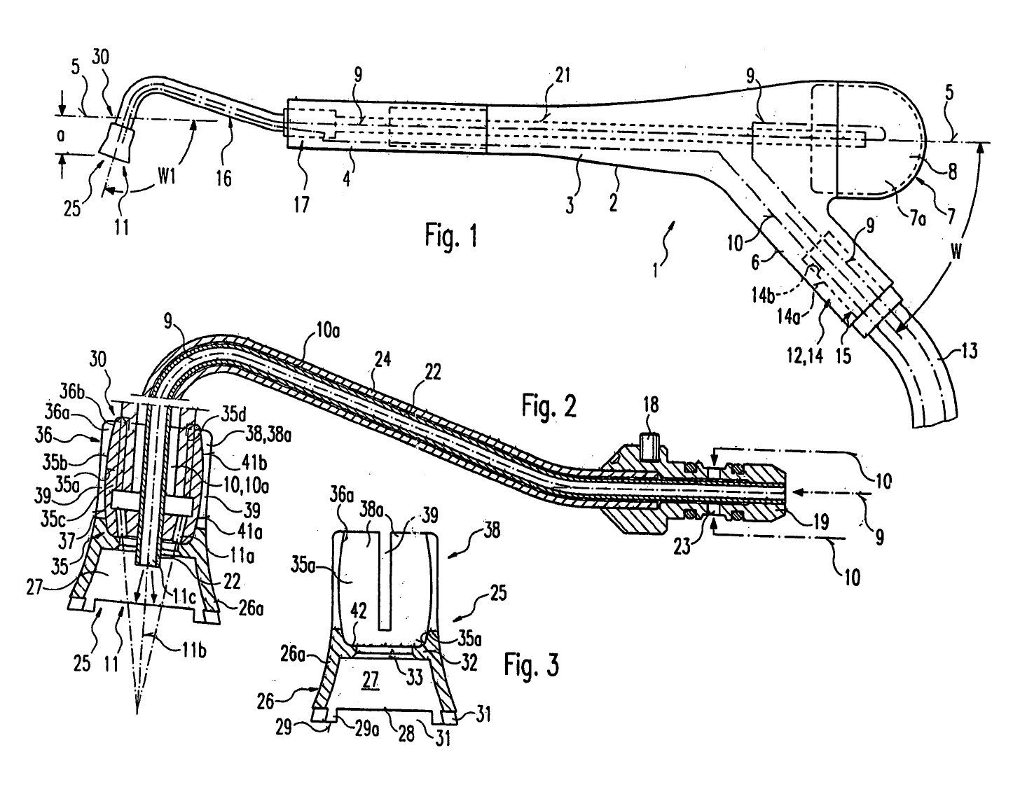

FIG. 1 a medical or dental-medical handpiece in accordance with the invention, having a splash guard in accordance with the invention, which e.g. is releasably connected with a cannula of the handpiece;

FIG. 2 the cannula in an enlarged representation, in longitudinal section;

FIG. 3 the splash guard as an individual part, in axial section;

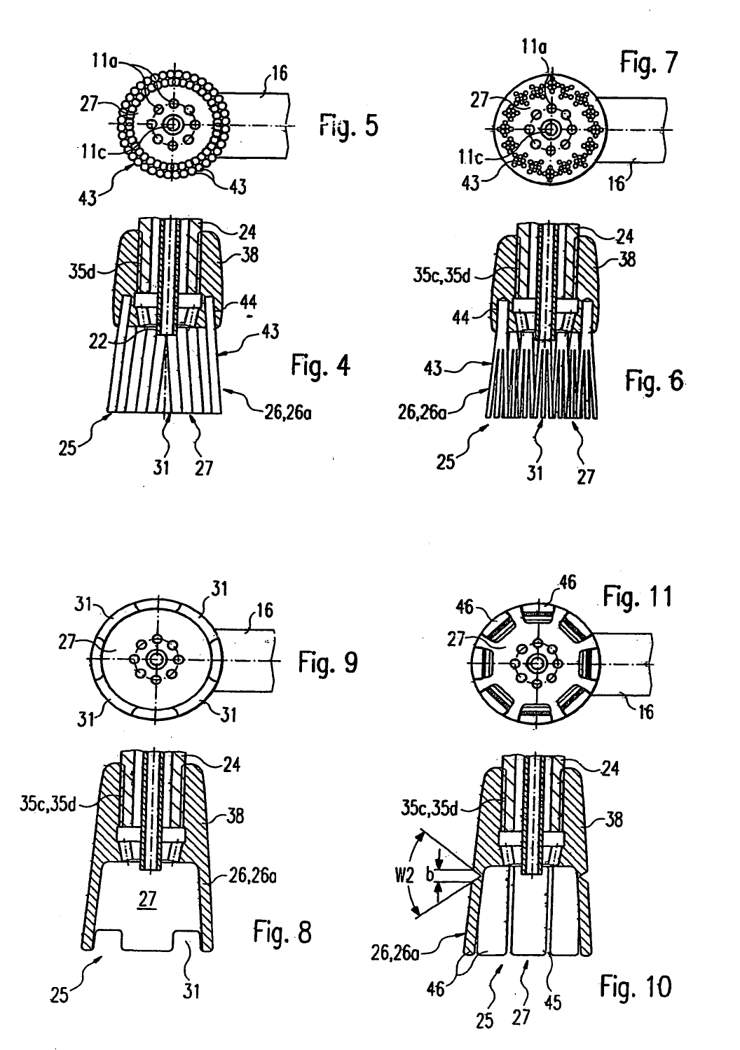

FIG. 4 the end region of a cannula and a splash guard in modified configuration, in axial section;

FIG. 5 the cannula and the splash guard according to FIG. 4, in a direction of view towards the outlet;

FIG. 6 the end region of a cannula and a splash guard in a further modified configuration;

FIG. 7 the cannula in the splash guard according to FIG. 6, in a direction of view towards the outlet;

FIG. 8 the end region of a cannula and a splash guard in a further modified configuration, in axial section;

FIG. 9 the cannula and the splash guard according to FIG. 8, in a direction of view towards the outlet;

FIG. 10 the end region of a cannula and a splash guard in a further modified configuration, in axial section;

FIG. 11 the cannula and the splash guard according to FIG. 10, in a direction of view towards the outlet;

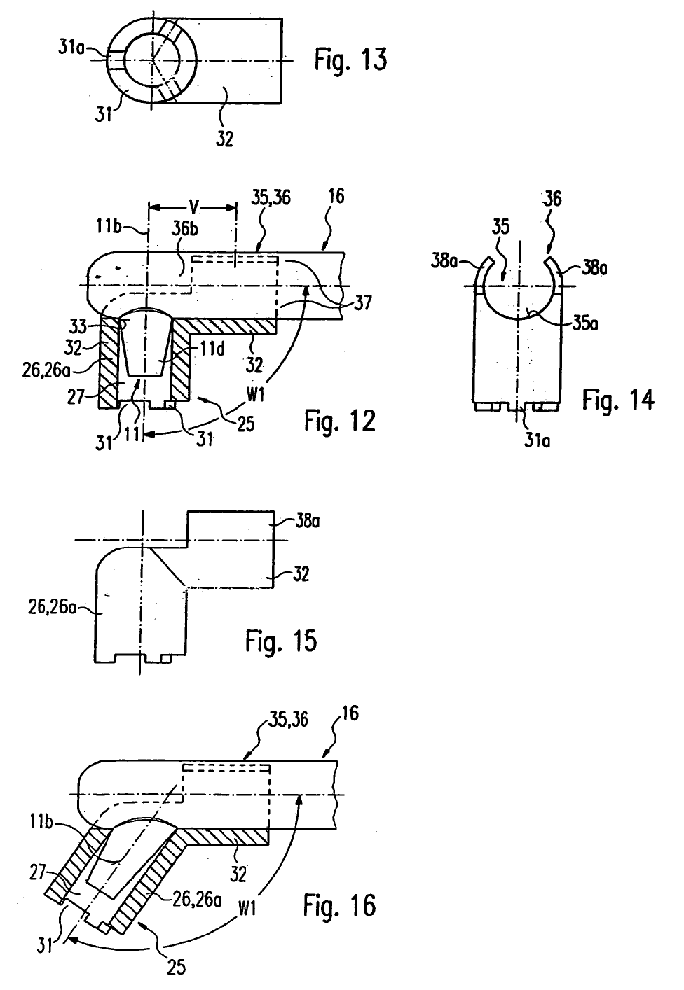

FIG. 12 the end region of a cannula and a splash guard releasably fixed thereon, in modified configuration, in axial section;

FIG. 13 a splash guard according to FIG. 12, in a direction of view towards its outlet;

FIG. 14 the splash guard according to FIG. 12, in a view from the front;

FIG. 15 the splash guard according to FIG. 12, in a view from the exterior;

FIG. 16 the end region of a cannula and a splash guard, in axial section in a further modified configuration;

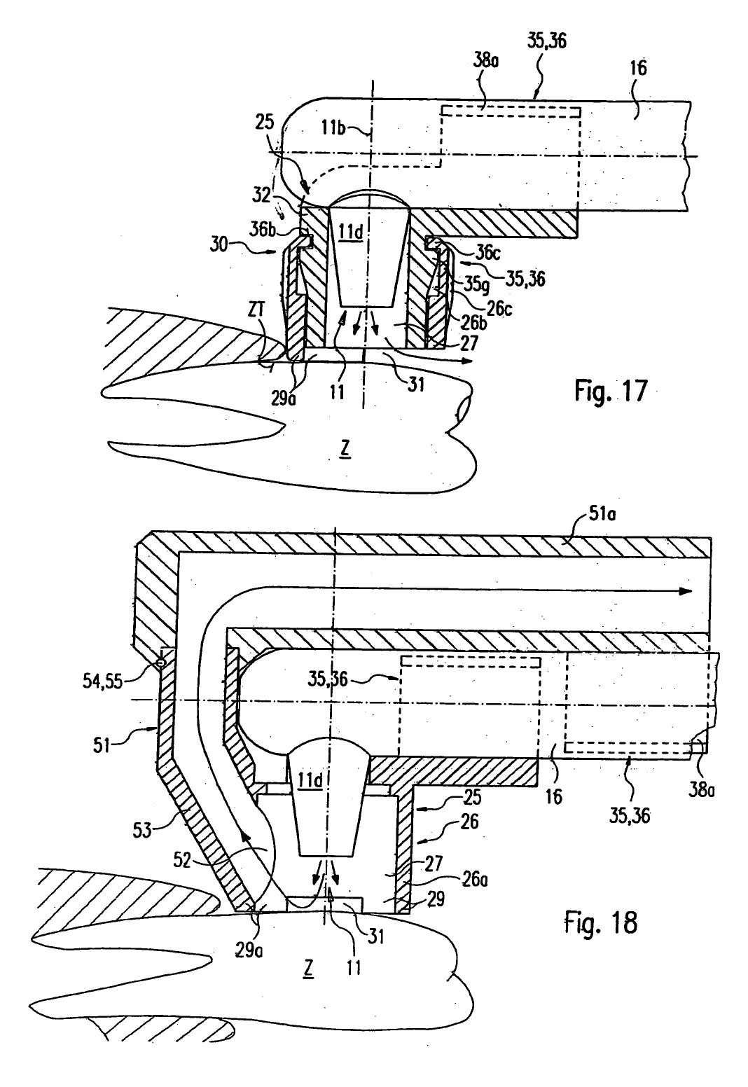

FIG. 17 the end region of a cannula and a splash guard releasably fixed thereon in a further modified configuration, in section;

FIG. 18 the end region of a cannula and a splash guard releasably fixed thereon, in further modified configuration, in axial partial section.

In the case of the exemplary embodiments described below, the same or similar parts are provided with the same reference signs.

The mains parts of the handpiece, designated in its entirety by 1, are an elongate handpiece body 2, in the case of the exemplary embodiment extending straight and rod-like, which has a shaft 3 from which a grip part 4 extends forwardly, wherein the shaft 3 and the grip part 4 are mounted on one another freely rotatably around their longitudinal middle axis 5. In the rearward region of the shaft 3 there are arranged a connection point 6 and a supply container 7, the supply chamber 7a of which is closed, and can be selectively opened, by means of a lid 8. From the connection point 6 there extends in the handpiece body 2 a delivery line 9 for a flow medium, e.g. air or compressed air or water, to an outlet 11 arranged at the forward end of the handpiece 1, wherein the supply chamber 7a is connected with the delivery line 9 in order to be able to deliver, in functional operation, the abrasive powder to the flow medium. In the case of the exemplary embodiment, the delivery line 9 extends into the supply chamber 7a and from the supply chamber 7a to the outlet, so that the flow medium flows into the supply chamber 7a, there mixes with the abrasive powder and flows as a flow mixture from the outlet 11.

In the case of the exemplary embodiment there are provided two delivery lines 9, 10 of which the second delivery line 10 is not connected with the supply chamber 7a and which extends directly to the outlet 11. The first delivery line 9 is provided for the delivery of a gas or air, while the second delivery line 10 is provided for a liquid flow medium, e.g. water.

The handpiece 1 is connected or connectable by means of a releasable quick connection 12 with a flexible delivery hose 13, which extends from a non-illustrated control apparatus and in which at least the first or both delivery lines 9, 10 extend from the control apparatus.

The quick connection 12 includes a coupling point at the forward end of the supply hose 13 and a coupling point, matching therewith, on the handpiece body 2, here on the connection point 6. Preferably there is provided a plug-in coupling or plug-in/turn coupling 14 with which the handpiece 1 can be readily and rapidly coupled with the supply hose 13. There is provided an approximately cylindrical coupling pin 14a and a matching coupling recess 14b which receives the coupling pin. In the case of the exemplary embodiment, the coupling pin 14a projects forwardly from the supply hose 13 and the coupling recess 14b is arranged in the rearward end region of the handpiece 1, here in the connection point 6, which may stand out to the side and include with the longitudinal middle axis 5 of the handpiece body 2 a rearwardly open acute angle W of e.g. about 45°.

For releasable securing against an unintended release of the plug-in/turn coupling 14 there is provided a latching device having a spring latching element 15, which is arranged in the coupling pin 14a or in the wall of the coupling recess 14b and which can in a springy manner so latch into, and for release be latched out of, a latching recess in the respective other part that upon plugging together of the plug-in coupling it self-actingly latches in and upon release by means of pulling apart, self-actingly latches out.

In the case of the exemplary embodiment, the supply container 7 is arranged at the rearward end of the handpiece body 2. Further, the outlet 11 is arranged at the free end of a cannula 16 extending from the forward end of the handpiece body 2—or, here, from the grip part 4—in a straight manner or at the same time to the side, which cannula is non-releasably or releasably connected with the handpiece body 2—here with the grip part 4—preferably by means of a quick connection 17, which may be e.g. a so-called bayonet connection. A bayonet connection has one or two connection pins 18, arranged opposing one another, on the one connection part, which can be introduced by axial insertion and turning into connection grooves in each case running axially and transversely in the circumferential direction on the other connection part, as is per se known. In the case of the exemplary embodiment the connection pin 18 stands radially out from the foot region of a cylindrical insertion pin 19, whereby the connection groove is arranged in the handpiece body 2 or in the grip part 4 and preferably has a latch-in point in the connection disposition.

The middle axis 11b of the nozzle 11a or of the nozzles 11a is preferably directed transversely of the middle axis 5 of 20 the handpiece 1. In the case of the exemplary embodiment the middle axes 11b and 5 include an approximately right or obtuse angle W1, which may be about 95°. It may, however, also be greater, as the exemplary embodiment according to FIG. 16 shows, in which case the angle W1 is about 135°. The cannula 16 may extend straight (FIGS. 12 and 16) or it may initially extend towards the side away from the side outlet direction, and then extend into the region of the longitudinal middle axis 5, whereby it may preferably project beyond this by an amount a as is shown in FIG. 1. Thereby, the cannula 16 may be initially bent obliquely away to the side and then be bent back towards the longitudinal middle axis 5 in the form of a section of a circular art.

The delivery line 9 for the abrasive flow medium extends from the supply chamber 7a preferably coaxially in the shaft 3 and grip part 4, whereby it continues likewise coaxially in the plug-in pin 19 of the cannula foot and in a cannula inner tube 22 to an outlet nozzle 11c. The second delivery line 10 for the liquid flow medium runs in the shaft 3 and the grip part 4, radially offset, whereby it may in this region be formed as a ring line which surrounds an inner tube 21 of the handpiece surrounding the associated delivery line section 9 and in the region of the inserted plug-in pin 19 flows through a radial channel 23 into a ring channel 10a extending between the cannula inner tube 22 and a cannula outer tube 24, which ring channel extends to the nozzles 11a arranged distributed on a part-circle at the end of the cannula 16, the nozzles 11a being preferably convergently directed.

In functional operation, a centrally arranged gas-powder mixed jet is surrounded by a plurality of liquid jets which e.g. due to their convergence meet with the central abrasive jet and thereby form a mixture.

In functional operation the handpiece 1 serves to spray natural or artificial animal or human body parts with the abrasive powder, wherein the powder emerges under pressure out of the preferably central nozzle 11a and impacts on the surface of the body, e.g. for the purposes of cleaning or the abrasive removal of material. In order to avoid that the abrasive flow mixture after the impact on the area to be treated distributes itself more or less uselessly, there is provided a splash guard 25 with a hood-form guard body 26, which at least partially surrounds a dome-shaped free space 27 into which the nozzles 11a, 11c open in the direction towards the opening 28 of the free space 27. In order also to ensure a flow when the hood-form guard body bears with its free edge on the surface to be treated there are provided in the circumferential wall 26a recesses 31 which run out at the free edge 29, e.g. three recesses 31 are distributed on the circumference, between which segment-like edge sections 29a are arranged. Thereby, the circumferential wall 26a can extend divergently from a base section 32 of the guard body 26. The base section 32 is formed ring-shaped and surrounds a through jet opening 32 for the nozzles 11a, 11c.

The splash guard 25 is connected with the handpiece 1 or a part mounted thereon, e.g. the cannula 16, by means of a preferably releasable connection 30.

For the manual handling-friendly and rapid connection of the splash guard 25 with the handpiece 1, here with the cannula 16 or a mounting part thereof, there is provided a quick connection 30a, e.g. a plug-in fitting 35 having a plug-in recess 35a and a plug-in pin 35b which can be inserted therein, wherein in the plug-in fitting 35 there is integrated a latching device 36 having a latching nose 36a which is elastically yieldable transversely to the insertion direction, which upon plugging together is elastically urged into its release position by means of guide surface 37 arranged before an undercut 36b, and in the latching disposition self-actingly springs into the undercut 36b and engages behind the latch body. The latter is preferably formed by means of the plug-in pin 35b. In the case of the exemplary embodiment according to FIGS. 1 and 2, the circumferential wall 38 of the plug-in recess 35b has at least one longitudinal slot 39 and on its inner periphery at least one latching nose 36a, which is arranged at an axial spacing from the base and over at least a part region of the inner periphery of the circumferential wall 38. Due to the slotted formation of the circumferential wall 38 its elastic deformability is increased, so that the region of the circumferential wall 38 which has the latching nose 36a is on the one hand so elastically deformable that the latching nose 36a upon plugging together on the one hand moves out of the way and in the plugged together condition springs into the undercut 36b, and on the other hand in this latched condition is so stable that the splash guard 25 is so fixedly arranged that in functional operation at the treatment site it cannot be unintentionally released, however can be released by means of manual axial pulling force for release, whereby the latching nose with the carrying circumferential wall section can elastically bend outwards.

In the case of the exemplary embodiment, the plug-in pin 35b is formed by an end section of the cannula 16, thickened in the sense of a cannula head, whereby the plug-in pin 35b has a thickening which is shaped in axial section in the form of a roof, having a cone-like tapering 41a towards the free end and a cone-like tapering 41b away from the free end. The first tapering 41a forms the guide surface 37 which upon plugging together urges the latching nose 36a into its released position, and the second tapering forms the undercut 36b into which the latching nose 36a latches.

Preferably the thickening having the taperings 41a, 41b is rounded in the manner of the form of a barrel.

There may be provided a single or a plurality of slots 39, arranged distributed around the circumference, preferably two slots 39 arranged mutually oppositely, whereby the circumferential wall 38 forms a tongue 38a which in the case of the exemplary embodiment is curved in cross-section.

The circumferential wall 38, or the at least one tongue 38a, is formed on the inside corresponding to the form of the thickening, so that it bears with its inner surface over a wide area on the outer surface of the thickening and through this acquires a firm seating. Thereby it is of advantage when the material of the circumferential wall 38 is of such a great firmness or hardness that the movement of the tongue 38a into the release position of the latching nose 36a occurs primarily due to elastic bending in the foot region of the tongue 38a. Through this, the seating is further stabilized. Further, the latching nose 36a extends in the circumferential direction over the entire circumferential width of the tongue 38a provided by means of the slotting.

The plug-in recess 35a is bounded inwardly by means of the base section 32 forming a radial shoulder 32. It contributes to the stability of the seating of the splash guard 25 if the plug-in recess 35a has a such a form and size that in the plugged together condition the edge of the end surface of the cannula 16 bears on the shoulder surface 42 and is supported thereby.

In the case of the exemplary embodiment, the plug-in pin 35b is formed by means of a U-shaped sleeve 35c with an end wall or nozzle head, which is inserted on or screwed on the outer pipe 24: see inner thread and outer thread 35d.

In the case of such configurations in which the plug-in fitting 35 is formed rotationally symmetrically with regard to its middle axis 11b, whereby thus the outer surface of the plug-in pin 35b and the inner surface of the plug-in recess 35a in each case have a rotationally symmetrical shape, the connection 30 forms a rotary connection 30b which makes it possible to rotate the guard body 26 around the preferably centrally running axis 11b, whereby the guard body 25 is carried by the other part of the splash guard 25, forming a base section 32. The rotary connection 30b may be integrated in the connection 30 or quick connection 30a, or it may also be formed separately thereof.

The exemplary embodiments according to FIGS. 4 and 5 differ from the above-described exemplary embodiments in two respects, whereby these differences may be provided in selective combination.

On the one hand, for the connection of the splash guard 25 there is not provided a plug-in fitting with latching device, but a screw connection, having the inner threading 35d in the sleeve-like circumferential wall 38, with which the circumferential wall 38 is screwed on to the outer threading 35d of the outer cannula tube 24.

On the other hand the circumferential wall 26a of the hood-form guard body 26 is formed by means of brushes or thin pins 34, which are arranged in the circumferential direction closely on one another or may have a spacing from one another, through which the recesses 31 are formed. The pins 43 may be arranged parallel or divergent towards their free ends, through which the recesses 31 are likewise provided. The pins 43 may also be arranged in two circumferential rows, and this closely neighboring one another or having a spacing from one another and/or being offset with reference to the outer pins 43. The pins 43 are of an elastically flexible material so that under the flow pressure they can elastically bend outwardly, through which the recesses 31 are likewise provided. Otherwise, the pins 43 may be formed on in one piece on the circumferential wall 38 or be placed in holes 44 arranged therein, and fixed therein, e.g. by gluing or press fitting.

In the case of the exemplary embodiment according to FIGS. 6 and 7, the pins 43 are spliced in their free end regions, through which their elastic bendability and flexibility is increased.

The exemplary embodiments according to FIGS. 8 and 9 show a ring-like closed circumferential wall 38 with edge recesses 31 and a screw connection for releasably screwing with the cannula 16 in the manner of the exemplary embodiment according to FIGS. 3 and 5.

The exemplary embodiment according to FIGS. 10 and 11 shows a circumferential wall 26a which is divided into tongues 46 or segments by means of a plurality of longitudinal slots 45, whereby the tongues 46 may bear on one another or have a spacing from one another directed in the circumferential direction. The elastic bendability of the tongues 46 can be increased by means of notch-like weakening, in particular in the foot region. The notches 47 or the cuts may in each case form a film hinge around which the tongue is transversely bendable outwardly and inwardly. If the notches 47 are arranged outwardly, as shown in FIG. 10, the maximum bending out angle W2 can be restricted by means of the notch width b. Also in the case of this configuration, the splash guard 25 is connected with the cannula 16 by means of a screw connection. As with all other exemplary embodiments there may, however, be provided also here a plug-in fitting 35 with a latch device 36 in the manner described above.

In the case of the exemplary embodiments according to FIGS. 12 to 16 the handpiece 1 has a e.g. straight extending cannula 16 with an outlet 11 arranged and directed to the side, which is arranged in a corresponding side outlet piece 11d, whereby the middle axis 11b may include, with regard to the longitudinal axis of the cannula 16, the right angle W1 (FIG. 12) or the obtuse angle W1 (FIG. 16) of e.g. about 135°. In the case of these exemplary embodiments, the splash guard 25 has a latching device 35 which so elastically engages over the cannula 16, preferably circular in cross section, in a C-form in the manner of a clasp, that the splash guard 25 can be manually clipped on and again clipped off. Through this, one or preferably both spring tongues 38 can move out over the cannula 16 and upon clipping on engage therebehind. Due to the round cross-sectional form of the cannula 16 there is provided of itself in each case a guide surface 37 and an undercut 36b, due to the shaping. In the case of the exemplary embodiment there is provided a base section 32 in an arc-section form shape, from which the at least one spring tongue 38a continues. In the case of the exemplary embodiment, the base section 32 and the spring tongues 38a include a circular section shaped form, the cross-sectional size of which in the relaxed condition of the elastic spring tongues 38a is smaller than the cross-sectional size of the cannula 16, so that in the clipped on condition the spring tongues 38a press against the cannula 16 with an elastic biasing. Through this, a clamping seating is ensured. Already through this, an axial securing of the splash guard 25 on the cannula 16 can be ensured. In the case of the exemplary embodiment, for axial securing, the opening 33 in the base section 32 is adapted to the cross-sectional size of the outlet piece 11d with play for movement. The outlet piece 11d has preferably a cross-sectional form tapering towards its end, e.g. in a cone shape, through which the plugging on is facilitated and is handling-friendly.

Also with the exemplary embodiments according to FIGS. 12 to 16 there is thus present a plug-in fitting 35 having an integrated latching device 36 for the splash guard 25.

Beyond this, in the case of these exemplary embodiments, the clamping section having the at least one spring tongue 38a is arranged laterally offset with regard to the circumferential wall 26a or its middle axis; in the clipped-on condition rearwardly offset. Due to the offset V of the latching device 36 rearwardly, a thickening of the cannula 16 in its forward region is omitted, so that due to the oblique viewing direction of the person carrying out the treatment, the view of the treatment site is improved. Beyond this, in the forward region of the cannula 16 the structural size is reduced, which in particular with regard to the restricted space for movement in the mouth region of a patient is of significance.

In the case of the exemplary embodiment, the base section 32 is laterally extended with regard to the circumferential wall 26a, whereby the latching device 36 is arranged in the laterally extended region of the base section 32 and is thus laterally offset.

In the case of this exemplary embodiment the splash guard 25 may be formed, with regard to the circumferential wall 26a, correspondingly to the above-described exemplary embodiments. As FIGS. 12 to 16 show there is provided a circumferential wall 26a, e.g. hollow cylindrical, closed in the circumferential direction, which at its free edge has recesses 31 arranged distributed on the periphery, e.g. three recesses, the axial depth of which is smaller than the inner cross-sectional dimension of the guard body 26. The dimension of the preferably uniformly sized recesses 31, in the circumferential direction, is greater than, e.g. approximately twice as great as, the dimension in the circumferential direction of the edge sections 29a present between the recesses 31.

The splash guard 25 is preferably an economically producible injection molded part, which is in particular of plastics material, e.g. of transparent plastics material, through which the visual observation of the treatment site is improved. As already with the above-described exemplary embodiment, also with the exemplary embodiments according to FIGS. 12 to 16, the splash guard 25 may be of relatively hard material, whereby the elastic yieldability of the latching device 36 is ensured due to the presence of at least one spring tongue 38a in the manner of a spring arm.

In the case of the exemplary embodiment according to FIG. 17, the guard body 26 is likewise connected with the carrier base 32 by means of a rotary connection 30b and thus mounted on the carrier base 32 rotatably around the preferably centrally running axis 11b. Also in the case of this exemplary embodiment, the rotary connection 30b is preferably integrated in the, if applicable, second connection 30 or plug-in fitting 35 or latching device 36, whereby the parts ensuring the form-fitting connection and the parts ensuring the rotary guiding, may be the same parts. The connection 30 is preferably a latching device 36 having an undercut 36b, formed by means of a ring groove, in the base section 32. The guard body 26 has on its edge towards the base section 32 and inner beading 36c which engages into the undercut 36b, e.g. formed by means of a ring groove, with play for movement. By means of this engagement there is ensured not only the latching, but also the rotary guiding. Instead of a ring-shaped inner beading 36c there may also be provided beading segments arranged distributed on the circumference. The mounting of the guard body 26 into the rotary connection 30b or into the latching is ensured in that the guard body is of elastically yielding material at least in the region of the inner beading 36c and thus upon axial pushing on, onto the carrier base 32, is radially elastically expanded and elastically springs into the undercut 36b. In corresponding manner, the guard body 26 can be released by means of an axial exercise of force in the other axial direction, if a releasable latching is desired. For simplification of the pushing on and, if applicable, also the pulling off, of the guard body 26, onto or away from the carrier base 32, there may be arranged on the carrier base 32, before or at the undercut 36b or on the inner beading 36c, rounded or oblique guide surfaces. In the case of the exemplary embodiment, the undercut 36b is formed by means of an outer beading 35g on the sleeve-like extended carrier base 32. In the region of the outer beading 35g the likewise sleeve-shaped guard body 26 has an inner ring groove. In order to be able to easily manually rotate the guard body 26, its outer surface is structured, through which grip-ability is increased. There may also be provided longitudinal ribs 26c or longitudinal grooves.

In particular in the case of a rotatable guard body 26 it is advantageous to form an edge section 29a, at the edge of the guard body 26, which extends in substance over the half circumference of the guard body 26, whereby the remaining edge can be formed without at least one edge section or may have one or more short edge sections 29a. The edge section 29a extending over about half of the circumference is thus advantageous because in functional operation of the handpiece 1, upon application of the guard body 26 at the treatment site, e.g. at a tooth Z, it blocks the exit of the mixture jet to the side at which this edge section 29a is located. This is thus in the position to protect a particular side from an impacting with the emerging mixture jet. Thus, this guard body 26 is suitable for protecting tooth socket ZT when this edge section 29a is located on the side which should be protected. In so far as access to the treatment site is sufficiently great, this advantage can also be exploited with a non-rotatable guard body 26, in that the handpiece 1 is correspondingly rotated. If, on the other hand, the guard body 26 is rotatable, selective arrangement dispositions for the edge section 29a can be set.

Beyond this, the carrier base 35f may be connected or connectable with the handpiece 1 or the cannula 16 in the sense of the exemplary embodiment according to FIGS. 12 to 15 or also 16. It is also possible to releaseably connect the carrier base 35f with the cannula 16 by means of a latching device in accordance with FIGS. 2 and 3.

In the case of the exemplary embodiment according to FIG. 18 a discharge line 51 extends from the circumferential wall 26a of the guard body 26, which line extends rearwardly, e.g. approximately parallel to the cannula 16, and is connected with a non-illustrated suction device, which e.g. may be arranged in the non-illustrated control apparatus. The discharge line 51 is in functional operation a suction line, which preferably can be selectively switched on, and with which used jet media mixture can be discharged by means of suction working. In the case of this configuration at least one recess 31 in the edge 39 of the guard body 26 is not necessary, since the jet medium can be discharged by means of the discharge line 51. In order, however, in functional operation to avoid temporary jet media blockages, it is advantageous also with this configuration to provide one or more recesses 31 in the sense of the above-described configurations.

In the case of the exemplary embodiment, the discharge line 51 extends from a discharge opening 52 in the circumferential wall 26a. The opening 52 is formed by means of a discharge pipe point 53, which is arranged for example on the forward side of the guard body 26 which in the case of the exemplary embodiment is formed non-rotatably and in one piece on the carrier base 25f and preferably extends curved or in an angled shape to the middle axis of the cannula 16. The pipe piece 53 is connected by means of a releasable pipe-line or hose coupling 54 with a discharge line section 51a which in its forward region extends from the hose coupling 54 in an angled shape or curved and then extends approximately axially rearwardly. It is advantageous to fix the discharge line 51 on the cannula 16. This can be effected by clipping on. In the case of the exemplary embodiment there is provided a plug-in fitting 35 or latching device 36, comparable with the plug-in fitting 35, or latching device 36 in accordance with FIGS. 12 to 16, provided with mutually oppositely arranged spring tongues 36a which form a C-shaped, clasp, which elastically engages over the cannula 16. The connection of the discharge line 51 is preferably arranged behind the connection for the splash guard 25.

In the case of the exemplary embodiment, the discharge line 51 with its return section 51a are located on the side opposite to the outlet 11 or splash guard 25. The discharge line 52 can, however, also extend rearwardly at another circumferential position of the cannula 16, whereby the discharge opening 52 or the pipe point 53 may be arranged, with regard to the circumferential wall 26a, to the side or to the rear. As is already the case with the above-described exemplary embodiments, the splash guard 25 or the guard body 26, the pipe points 53 and the discharge line 52 are preferably of plastics material, whereby the discharge line 51 may be of flexible plastics material.

The hose coupling 54 is preferably formed by means of a bushing-like connection, with which the discharge line 51 can engage over the pipe point 53 with an elastic tensioning. Instead of such a force-locking fixing there can also be integrated in a form-locking elastically effective latching device 55 in the hose coupling 54, e.g. with at least one latching element which elastically latches into an undercut and by means of an axial pressing or pulling force can be overcome, and is thus latchable and releasable.

In the case of all exemplary embodiments it is advantageous to provide a plurality of splash guard parts 25 or a plurality of guard bodies 26 which differ from one another and which can be selectively connected with at least one associated handpiece 1 or with at least one base part 32. Depending on the different configuration, through the selective use, and adaptation of the handpiece 1 or of the splash guard 25 or of the guard body 26 to the treatment site and/or to different treatments is possible. The difference can be realized e.g. by means of different edge sections 29a or different guard body sizes or different guard body heights c. Different guard body heights or differently high free spaces 27 may be necessary depending upon the medical situation. It is e.g. advantageous to provide a plurality of splash guard parts 25 or guard bodies 26 of free space heights from 0.5 mm to 5 mm through which, with the use concerned of a desired splash guard part 25 or guard body 26 the spacing of the outlet 11 from the surface to be treated can be set. The free space height or the height of the guard body 26 is designated by c.

Since, for the transport of the abrasive powder to the outlet 11, only one transport fluid is needed, the handpiece 1 may have only one delivery line 9, in particular for the compressed gas, or two delivery lines 9, 10, in particular for compressed gas and water. In the case of the exemplary embodiments according to FIGS. 12 to 18, the handpiece 1 is configured for only one transport medium, namely for the delivery of compressed gas through the delivery line 9. For purposes of rationalization it is advantageous to form the handpiece 1 with two delivery lines 9, 10 and in the case in which only pressure gas as transport medium is used to block the second delivery line 10, preferably in the initial region of the delivery line 10 concerned, in particular in the region of a part which is put into place in the connection point 6 and has the associated coupling part, here in the form of the recess 14b.

### List of Reference signs

1 handpiece
2 handpiece body
3 shaft
4 grip part
5 longitudinal middle axis
6 connection point
7 supply container
7a supply chamber
8 lid
9 delivery line
10 delivery line
10a ring channel
11 outlet
11a nozzle
11b middle axiss
11c nozzle
11d outlet point
12 quick connection
13 delivery hose
14 plug-in/turn coupling
14a coupling pin
14b coupling recess
15 latch element
16 cannula
17 quick connection
18 connection pin
19 plug-in pin
20 no description
21 inner tube
22 cannula inner tube
23 channel
24 cannula outer tube
25 splash guard
26 guard body
26a circumferential wall
26b inner ring groove
26c longitudinal rib
27 free space
28 opening
29 edge
29a edge section
30 connection
30a quick connection
30b rotary connection
31 recess
32 base section
33 jet through opening
34 no description
35 plug-in fitting
35a plug-in recess
35b plug-in pin
36 latching device
36a latching nose
36b undercut
37 guide surface
38 circumferential wall
38a tongue
39 longitudinal slot
40
41a tapering
41b tapering
42 shoulder
43 pin
44 hole
45 longitudinal slot
46 tongue
47 notch
48
49
50
51 discharge line
51a discharge line section
52 discharge opening
53 pipe piece
54 hose coupling
55 latching device
V offset
W angle
W1 angle
Z tooth
ZT tooth socket
a measure
b notch width
c height

1-21. (canceled)

22. Medical handpiece, comprising in a rearward end region a coupling connection for coupling on to a flexible supply hose, with at least one delivery line for an abrasive flow medium extending from the coupling connection to an outlet which is arranged in a forward end region of the handpiece and opens into a hood-form free space of a splash guard which is releasably connected with the handpiece by a plug-in fitting having two plug-in fitting parts in the form of a plug-in recess and a plug-in pin that can be inserted therein, and a latching device integrated in the plug-in fitting, wherein the plug-in fitting has a spring tongue, elastically outwardly bendable transversely to the plug-in axis, with a latching nose arranged thereon on the one plug-in fitting part and an undercut on the other plug-in fitting part.

23. Handpiece according to claim 22, wherein the spring tongue is arranged on the plug-in fitting and the undercut is arranged on the plug-in pin.

24. Handpiece according to claim 22, wherein the plug-in fitting has a circumferential wall surrounding the plug-in recess, which wail is slotted by at least one longitudinal slot.

25. Handpiece according to claim 22, wherein the plug-in pin is arranged in an end region of a cannula, wherein the plug-in pin is formed by means of a sleeve inserted on or screwed on to the cannula.

26. Handpiece according to claim 25, wherein the cannula is releasably connected with a grip part of the handpiece.

27. Handpiece according to claim 22, wherein the plug-in pin has, in axial section, a thickening with a first converging part towards a free end and a second converging part away from the free end, of which the first converging part, upon the plugging together of the plug-in fitting parts, forms a guide surface which urges the latching nose into a release position, and the second converging part forms the undercut.

28. Handpiece according to claim 27, wherein the thickening is formed by a ball section shaped rounding.

29. Handpiece according to claim 27, wherein the thickening is formed by a barrel-shaped rounding.

30. Handpiece according to claim 22, comprising at least two longitudinal slots dispersed about the circumference.

31. Handpiece according to claim 30, comprising two mutually opposed longitudinal slots.

32. Handpiece according claim 22, wherein at least one of the latch nose and the spring tongue bears on the plug-in pin with a bias.

33. Handpiece according to claim 22, wherein the spring tongue is, in axial section, convergently shaped at an inner side, whereby the shape of the inner side is adapted to the shape of a plug-in pin on the handpiece.

34. Handpiece according to claim 22, wherein the hood-form free space diverges towards an opening thereof.

35. Handpiece according to claim 22, wherein a circumferential wall surrounding the free space has in an edge region thereof at least one recess distributed around its circumference.

36. Handpiece according to claim 22, wherein a circumferential wall surrounding the free space is formed by means of brush-like pins which in the circumferential direction lie closely on one another or have a spacing from one another.

37. Handpiece according to claim 33, wherein in a forward region the pins are spliced.

38. Handpiece according to claim 33, wherein the pins are formed by means of segments.

39. Handpiece according to claim 33, wherein the pins have, at a spacing from their free end, in each case a cross-sectional weakening.

40. Handpiece according to claim 39, wherein the weakening is defined by a notch on the outer side of each pin.

41. Splash guard for a medical handpiece, which has in a rearward end region a coupling connection for coupling on to a flexible supply hose, at least one delivery line for an abrasive flow medium extending from the coupling connection to an outlet which is arranged in a forward end region of the handpiece, wherein the splash guard has a guard body having a hood-form free space into which a delivery line opens, and a plug-in recess having a latching nose arranged in its edge region, and is therewith releasably latched with the handpiece, the plug-in recess has associated therewith a spring tongue, elastically bendable outwardly transversely to the plug-in axis, having a latch nose arranged thereon, which latch nose is formed by means of at least one longitudinal slot a circumferential wall of the plug-in recess.

42. Splash guard according to claim 41, wherein at the edge of the guard body there is arranged at least one projecting edge section which form recesses arranged to the side with reference to the longitudinal axis of the cannula, which edge section extends over approximately the half over the circumference of the circumferential wall of the guard body.

43. Splash guard according to claim 41, comprising a plurality of splash guard parts or guard bodies having different heights of their free spaces.

44. Splash guard for a medical handpiece, which has in a rearward end region a coupling connection for coupling on to a flexible supply hose, wherein at least one delivery line for an abrasive flow medium extends from the coupling connection to an outlet which is arranged in the forward end region of the handpiece, wherein the splash guard has a guard body having a hood-form free space into which a delivery line opens, and wherein the splash guard has a plug-in recess having a latching nose arranged in an edge region, and is therewith releasably latched with handpiece, wherein the connection is a rotary connection in which the splash guard body is rotatable around an axially extending axis of rotation.

45. Splash guard for a medical handpiece, which has in a rearward end region a coupling connection for coupling on to a flexible supply hose, wherein at least one delivery line for an abrasive flow medium extends from the coupling connection to an outlet which is arranged in a forward end region of the handpiece, wherein the splash guard has a guard body having a hood-form free space into which a delivery line opens, and wherein the splash guard is releasably connectable with the handpiece, wherein a plurality of different splash guard parts are provided, which parts can be selectively connected with the handpiece.

46. Splash guard according to claim 45, wherein the plurality of different splash guard parts can be selectively connected with the handpiece by a quick connection.

47. Splash guard for a medical handpiece, which has in a rearward end region a coupling connection for coupling on to a flexible supply hose, wherein at least one delivery line for an abrasive flow medium extends from the coupling connection to an outlet which is arranged in the forward end region of the handpiece, wherein the splash guard has a guard body having a hood-form free space into which a delivery line opens, and wherein the splash guard is releasably connectable with the handpiece, wherein the splash guard is screwed on to a free end region of the handpiece or on to a cannula preferably releasably connected with a grip part of the handpiece.
